(19) United States
(12) Patent Application Publication
(10) Pub. No.: US 2004/0081766 A1
(43) Pub. Date: Apr. 29, 2004

(54) Under water coating method

(76) Inventor: Ahmad Zolghadri, Flagstaff, AZ (US)

Correspondence Address: AHMAD ZOLGHADRI, P.O. BOX 2308, FLAGSTAFF, AZ, 86003, US

(21) Appl. No.: 10/195,201

(22) Filed: Oct. 28, 2002

(51) Int. Cl. B05D 3/02

(52) U.S. Cl. 427/385.5

(57) ABSTRACT

Marine Structure platforms and pillars are consistently subject to corrosion.

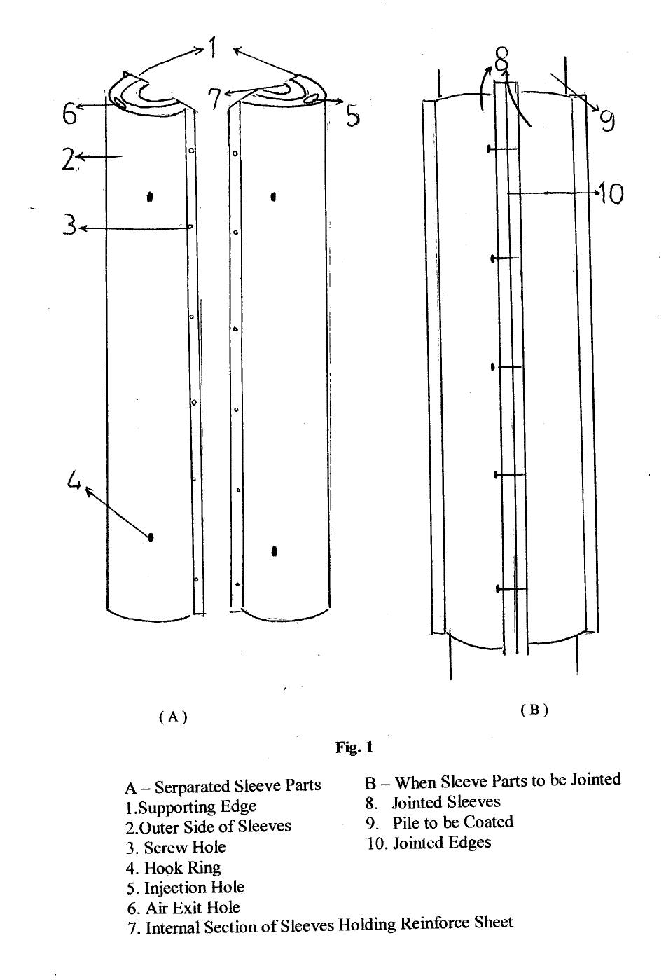

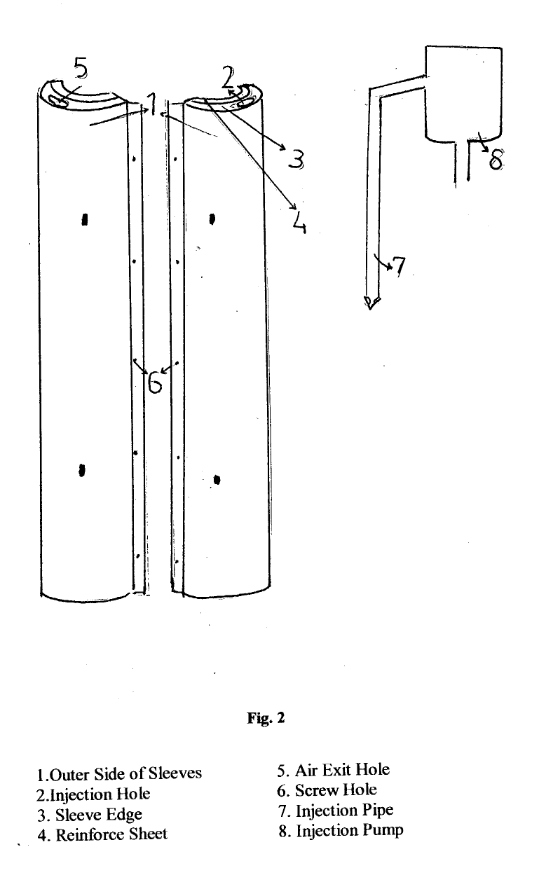

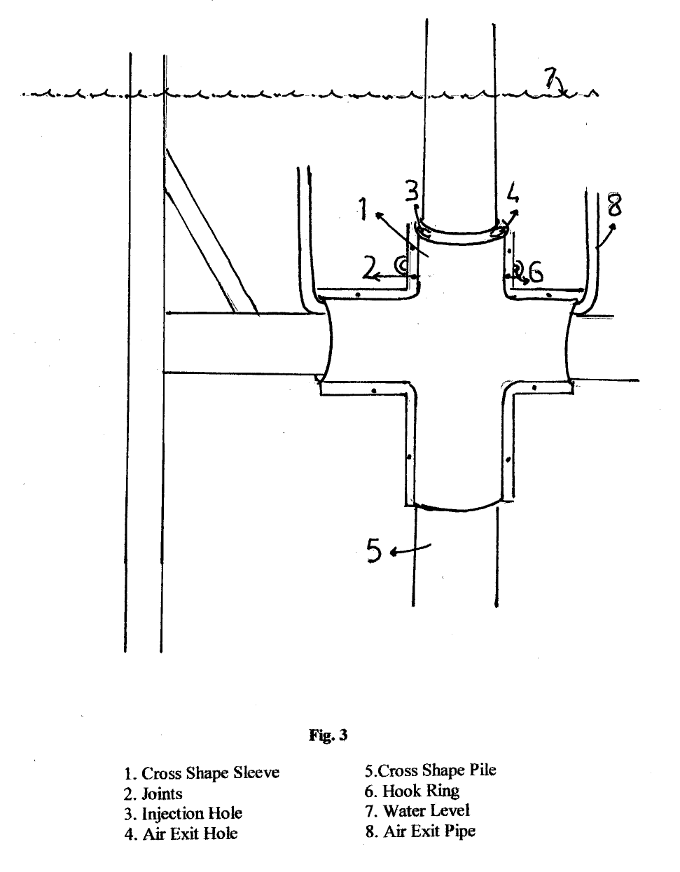

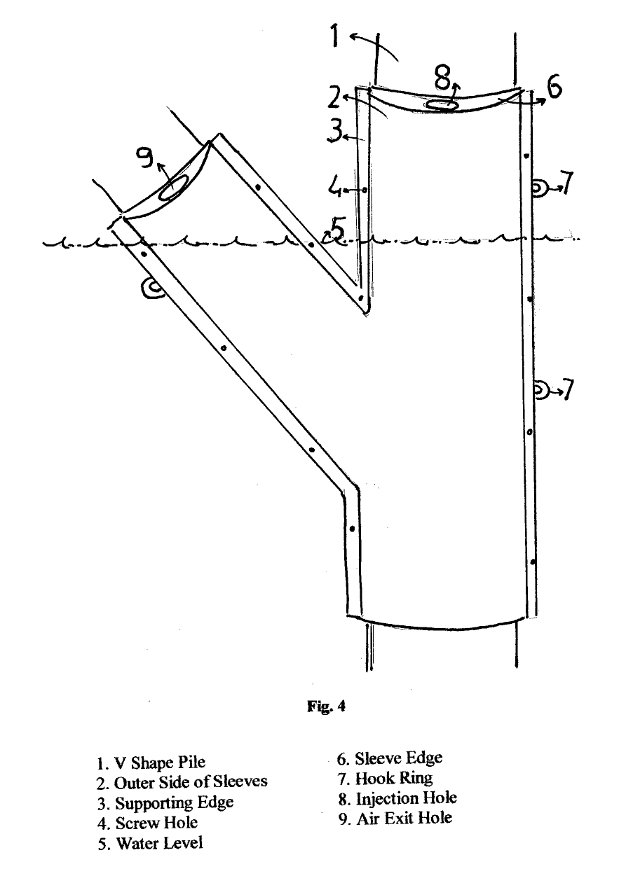

This patent claim is utilizing steel shuttering for polymer coating at tide water level.

Sleeve is fabricated, angle iron welded to edges, drilled for bolting. One side may be hinged. Shaped flats welded to cover top and bottom gaps between sleeve and structure. Holes drilled on top for water vacuum, air and polymer injection. Internal surface of sleeve covered with grease and glass wool, extended to edges of angles to be bolted between sealing gaskets. Sleeve connected to gantry chain block and lowered below the low tide, bolted to structure and sealed. The water between sleeve and structure vacuumed through one hole while air pumped through another, then polymer injected inside until polymer appears through opposite hole. Two upper holes must be plugged, then alternatively opened every ten minutes releasing gases. Sleeve removed three hours later.

### SUPPLEMENTARY TECHNICAL DESCRIPTION

Injection Method A

With this method coating can be done either reinforced or non reinforced. In this execution method polymerization occurs with the presence of water and formation of foam. The density of foam depends on the injection of coating material, quantity of water in causing sleeve and expansion due to composition of polymer A and B components of polyurethane with water. As an average it can be assumed that 80% of anti corrosion coating thickness will be in a proper adhesive form. Secondly because of closed area and fusion of polymer in the long run versatility of molecules will be more strong and coating firmness will be ever increasing, but it will face bubbles due to composition of polymer components with water. Consequently a coating of 1000 microns will be resistant to 15000 volts of electricity and all together the polymer coating as an anti corrosion and abrasion may last 15 to 20 years.

Injection Method B

Composition of polymer components, the two basic ones in presence of water create excessive gas and polymer turns to a foam substance. Therefore in method B water which is in contact with the polymer coating and composition of components is to be discharged according to the following procedure.

1. Lateral joint of sleeve is completely sealed.

2. After closing joint water is vacuumed by three V shape vacuum pumps fixed along sleeve joint and air is pumped inside the sleeve with a pressure equal to side water pressure and vacuum pressure of inside water. In this way penetration of water from sleeve joints is prevented and on the other hand inside surface is de watered and proportionately dry for coating application.

3. Injection pipe is inserted in the sleeve, from the point opposite to the upper air inlet and extended halfway down and coating polymer is injected inside the sleeve.

Important Notes

1. The injection of two component polymer compositions is carried out when fusion of polymer elements is primarily passed. Therefore considering ambient temperature and blending speed experience is required for utilization. About 15 minutes after primary composition of two basic elements and A Temperature about 20 degree C. polymer can be injected into the sleeve to the limit of opposite air inlet.

2. Simultaneous with injection of polymer into upper inlet one, the air pressure of upper inlet 2 is reduced gradually until after filling the sleeve the air pressure is cut off.

3. In both methods 1 and 2 mentioned above, after filling the sleeve, upper inlets 1 and 2 are plugged. This will cause volume pressure of injected coating to create more compression and maximum adhesion of polyurethane.

4. All the activities are carried out from the splash zone and above water level.

5. All the above method can be executed when reinforcement layer is used.

### Application of Polymer Coating

A—Fabrication of Sleeve

1. Measurements of marine structure are taken including outside diameter and length, under and above water level.

2. A piece of a pipe of larger diameter is chosen and cut in half longitudinally, cut by disk or industrial saw with a straight edge.

3. An angle iron of equilibrant thickness with pipe wall thickness is welded along the edge of the pipe so that both edges are flush and tangent.

4. Angle iron edges are drilled every 40 cm all along on both opposite edges to be connected with bolts and nuts.

5. One side of the half sleeve can be hinged instead of bolted edges.

6. The upper and lower edges or gaps between marine structure or pile diameter and sleeve diameter are properly covered with shaped iron strips and welded to the sleeve, so that when the sleeve is fitted around the pile, the gap in between is covered and strips are on the surface of pile.

7. All the upper, lower and longitudinal edges are sealed with rubber washer.

8. A hole is drilled in the middle of half circle, between the pile and sleeve for polymer injection, air injection and water vacuum.

9. Where sleeves are made in several branches, separate holes are drilled for each branch.

B—Preparation of Sleeve for Reinforced Coating

1. Internal surface of the sleeve is first covered with adhesive tape (clear or obscure) or ordinary grease.

2. A layer of glass wool tissue is placed on the grease layer which is to be sticked to the surface and becomes stable.

3. The edges of tissue are to be extended to the extreme surface of angle which will be bolted and sealed between sleeve washers.

C—Fixing shuttering sleeve

1. The complete sleeve tightened to a gantry chain, with a double capacity of sleeve weight., from the top section of the pile above water level.

2. A chain block prepared with a double capacity of sleeve weight for moving the sleeve up and down (hoisting operation). Sleeve chains are connected to the chain block above deck pile.

3. Sleeve is lower down to the required limit under water level about two meters below splash zone at low tide level.

4. At this stage the sleeve is strongly connected to the pile by proper bolts and nuts., so that the space around the pile and inside diameter of the sleeve is completely sealed. Now the sleeve is fixed and stable by chain block and connecting bolts and nuts on both edges of sleeve and pile.

D-Method of coating injection

1. First the water inside the sleeve between pile and sleeve is discharged by vacuum pump, through one of the top holes which has been drilled for this purpose, while compressed air is pumped in through another hole on the top surface.

2. After discharging water air compression inside the sleeve is continued until water moisture on the surface of pile is minimized or half-dry.

3. SBP coating polymer is injected into the sleeve by air pump until polymer appears or discharged from the apposite hole. At this stage injected polymer has completely occupied the space inside the sleeve.

4. The two upper holes are plugged so that injected polymer between sleeve and pile surface due to volume expansion under pressure of polymer two component reactions, is quite sticked to the pile surface.

5. At this stage the injected polymer which is quite saturated inside the sleeve, penetrates into the reinforcement glass wool all over the pile wall surface.

6. Every ten minutes one of the upper holes must be alternatively open and closed to release compressed gases during the final stage of polymer injection.

7. Sleeve can be removed three hours after completion of injection. Curing of polymer will continue in seawater as well as free atmosphere. Coating will be homogenous without crack or pinhole.

8. Checking inside surface of the sleeve should confirm accuracy of the job as mentioned in clause 7, if no deposits of polymer is seen on the sleeve, except angle iron edges and or bolts and nuts which are outside of the internal surface of the sleeve.

Explanation:

Sleeves can be prepared and used for other piles and marine structures, after completion of each injection operation.

Mean while several sleeves can be made ready and used for separate locations at the same time as required.

1. Marine Structure particularly Oil and Gas rigs and platforms, light house (marine guide lights) pillars and jetties are consistently subject to severe corrosion due to existence of chlore ion. Maximum corrosion occurs in splash zone area due to existence of multiple salts and oxygen.
To protect marine structure anticorrosion polymers are used and cathodic protection systems are often used for sub water or deeper areas.
Two component polymers such as epoxies and polyurethane are common protection layers around splash zone but execution of coating necessitates surface preparation de-watering and surface drying.
To achieve assurance factor of coating underwater of structures surface must be coated to the limit of low tide, because high tide waves at splash zone eventually drop to the lower parts and sub water surface of structure where oxygen would be present, causing oxidization and corrosion.
This patent claim is relevant to fabrication and utilization of steel shuttering for the proper and reliable polyurethane polymer coating of two components produced according to ASTM D16 standard for marine structure at any water level between high and low tide.
Innovation of this method and fabrication of the equipment as described, together with necessary practical and theoretical training will facilitate the best way for marine maintenance personnel to prevent corrosion and remedy defects on marine structure members at splash zone, up and down, with less expense, less danger, excessive speed and more assurance.
The result of more than two years experiments and practical examination of prefabricated shuttering sleeve has proven the feasibility of the patent.
Meanwhile in addition to superiority of this method to current methods, coating of the structure can be reinforced for physical strength.
Considering the fact that I do not know of any similar method of coating marine structure, I reserve the right to request for the registration of my patent.
